(19) United States
(12) Patent Application Publication
(10) Pub. No.: US 2003/0023673 A1
(43) Pub. Date: Jan. 30, 2003

(54) Auto-backup system and method for portable electronic device

(76) Inventor: Frank Tso, Taipei (TW)

Correspondence Address: BIRCH STEWART KOLASCH & BIRCH, PO BOX 747, FALLS CHURCH, VA, 22040-0747, US

(21) Appl. No.: 09/934,688

(22) Filed: Aug. 23, 2001

(30) Foreign Application Priority Data
Jul. 5, 2001 (TW) 90116523

(51) Int. Cl. G06F 15/16

(52) U.S. Cl. 709/203; 709/213; 714/7

(57) ABSTRACT

The specification discloses an auto-backup system for portable electronic devices implemented in a system comprising a portable electronic device and a network server. It includes an input module, a network connecting module and a backup management module. The input module receives a backup request entered by a user. The network connecting module establishes wireless signal communications between the portable electronic device and the network server after the input module receives the backup request. The backup management module transmits at least one set of data stored in the portable electronic device to the network server. After the network server receives the data, a backup I/O module stores the data in a network database. An auto-backup method for portable electronic devices implemented in the above-mentioned system is also disclosed herein.

### BACKGROUND OF THE INVENTION

1. Field of Invention

The invention relates to an auto-backup system and method and, in particular, to an auto-backup system and method for portable electronic devices that utilizes the wireless network function of the portable electronic devices to automatically back up data in the portable electronic devices to a network database.

2. Related Art

Thanks to the advances in electronic technology, small but powerful portable electronic devices are becoming cheaper and popular. Taking the personal digital assistant (PDA) as an example, it can provide such functions as a calendar, address book, notebook, calculator, clock, and games. Since they are small, slim, light and easy to carry and they are widely used by ordinary people.

However, normal portable electronic devices have the drawback that, due to volume limits and cost considerations, the storage capacity in its storage device is small. For an ordinary PDA, the data storage space is usually only 8 MB. With a flash memory card, the data storage space can be increased, at most, to 320 MB. Compared with the 40 GB storage space popular in current personal computers, the PDA indeed has a very limited amount of storage space.

Moreover, when a user wants to back up the data stored in his portable electronic device, he has to use a universal serial bus (USB) or an infrared (IR) transmission device to transmit data to a personal computer, thus storing the data in the storage device in the personal computer. This procedure is not only tedious but also bounds the portable electronic device to the personal computer. In other words, when the user is traveling or away from his personal computer, he is then unable to back up the data in his portable electronic device.

When the user wants to download the backup data, he also has to use the USB or IR transmission device to restore the data from the personal computer to the portable electronic device. This procedure is also time-consuming and bounds the portable electronic device to the personal computer. Again, when the user is traveling or away from his personal computer, he is then unable to restore the data to his portable electronic device.

In view of the foregoing, it is highly desirable to provide a large data storage device for the user to back up data in his portable electronic device when he is traveling or away from his personal computer.

### SUMMARY OF THE INVENTION

To solve the above problems, the invention provides an auto-backup system and method for portable electronic devices, which can back up data on portable electronic devices on a data storage device with a larger capacity.

Another objective of the invention is to provide an auto-backup system and method for portable electronic devices so that its user can wirelessly back up or restore data.

To achieve the above-mentioned objectives, the invention provides an auto-backup system for portable electronic devices implemented in a system including a portable electronic device and a network server. The system includes an input module, a network connecting module and a backup management module installed in the portable electronic device and a backup I/O module and a network database installed in the network server. In the invention, a user uses the input module in the portable electronic device to enter a backup request including an IP address. After the network connecting module receives the backup request, it immediately establishes signal communications between the portable electronic device and the network server according to the provided IP address. The backup management module transmits at least one set of data stored in the portable electronic device to the network server once the signal communications have been established. The backup I/O module in the network server then stores the transmitted data to the network database.

Moreover, the backup management module can automatically send out a data restoration request from the portable electronic device to the network server. The backup I/O module then follows the data restoration request to obtain the data from the network database needed for the restoration action. The obtained data are then transmitted to the portable electronic device. The above-mentioned data can be an application program, a file or a driver.

The invention also proposes an auto-backup method for portable electronic devices. It is implemented between a portable electronic device and a network server. The portable electronic device has an input module, a network connecting module, and a backup management module. The network server includes a network database and a backup I/O module. The network server has a definite IP address. The disclosed method includes a backup initiating step, a network connecting step, and a backup storing step. In accordance with the invention, a user enters a backup request using the input module in the backup initiating step. The network connecting step establishes communications between the portable electronic device and the network server according to the IP address. Finally, the backup storing step uses the backup management module to transmit at least one set of data stored in the portable electronic device to the network server. The backup I/O module then stores the transmitted data in the network database.

Furthermore, the disclosed auto-backup method for portable electronic devices also includes a data restoration step. When the portable electronic device executes an action, the backup management module automatically sends out a data restoration request to the network server. The backup I/O module follows the data restoration request to obtain the data from the network database needed for the above-mentioned action and sends the obtained data to the portable electronic device.

Since the disclosed system and method can transmit and store data in the portable electronic device to a network database and the network database can provide a larger storage space than the portable electronic device can, the invention can therefore be used to back up data in a portable electronic device in a network database.

As the disclosed system and method can utilize the wireless connection function of the portable electronic device to access backup data in the network database, the user can conveniently perform data backup and restoration actions.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a schematic diagram showing a preferred embodiment of the auto-backup system for the portable electronic device;

FIG. 2 is a flowchart showing a preferred embodiment of the steps in the auto-backup method for the portable electronic device; and

FIG. 3 is a flowchart showing a preferred embodiment of the data restoration step in the auto-backup method for the portable electronic device.

### DETAILED DESCRIPTION OF THE PREFERRED EMBODIMENT

The invention will be apparent from the following detailed description, which proceeds with reference to the accompanying drawings, wherein the same references relate to the same elements.

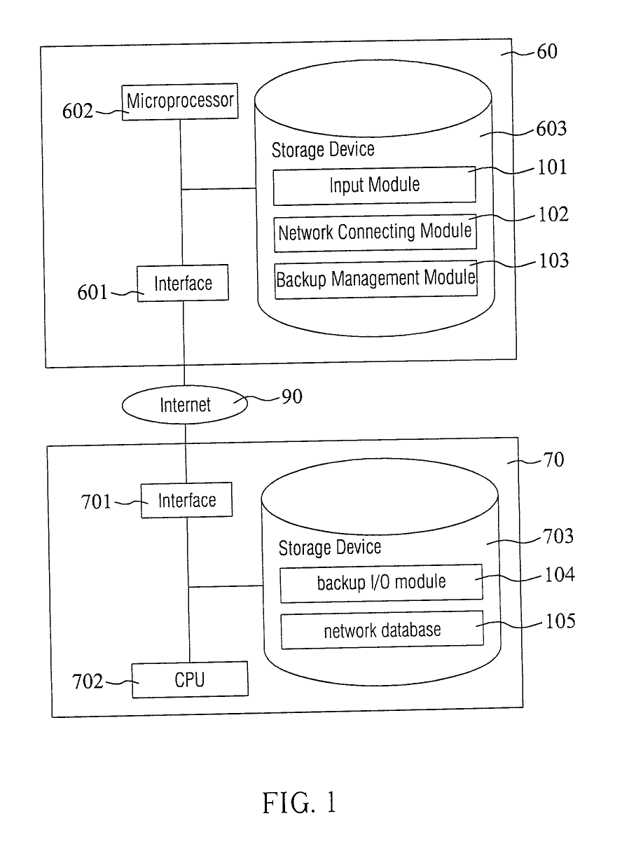

As shown in FIG. 1, the disclosed auto-backup system for portable electronic devices is implemented between a portable electronic device 60 and a network server 70. The portable electronic device 60 has an input module 101, a network connecting module 102, and a backup management module 103. The network server 70 includes a backup I/O module 104 and a network database 105. The network server 70 has a definite IP address.

In the current embodiment, the network server 70 is a conventional computer device, which has an interface 701, a central processing unit (CPU) 702, and a storage device 703. The interface 701 is an interface device that can establish signal communications with the Internet 90. For instance, it can be an Ethernet card. The storage device 703 can be a computer readable data storage device such as a hard disk drive (HDD), a CD-ROM, DRAM or EEPROM. The CPU 702 can be any central processor structure in the prior art, e.g. ALU, registers and controllers, for performing various data processing and operations and controlling the action procedure of each device in the network server 70.

The portable electronic device 60 uses the general packet radio service (GPRS) system to establish signal communications with the network server 70. That is, the portable electronic device 60 uses a radio frequency (RF) module to establish radio signal communications with a GPRS system base station (BS). Through serving GPRS supporting nodes and gateway GPRS supporting nodes, the portable electronic device 60 connects to ordinary packet digital networks. In general, the serving GPRS supporting nodes connect all subsystems of each BS so as to transmit digital data sent out from the portable electronic device 60 to the gateway GPRS supporting nodes. The gateway GPRS supporting nodes are the windows of the whole GPRS system. It provides a digital network protocol conversion logic interface to other packet digital networks. After receiving digital data transmitted by the serving GPRS supporting nodes, the gateway GPRS supporting nodes transfer the data to the host that communicates with the portable electronic device 60, i.e. the network server 70 in the current embodiment.

Each module in the current embodiment refers to the software module stored in the storage device 703 or 603. After loading in each module, the CPU 702 and the microprocessing unit 602 can implement the function of each module through devices in the electronic device, such an interface, an input device, an output device or other software modules. However, it should be understood that any skilled person could turn the software modules disclosed herein into hardware, such as an application-specific integrated circuit (ASIC), without departing from the spirit and scope of the invention.

In the current embodiment, a user enters a backup request using the input module 101 of the portable electronic device 60. The input module 101 can display a “Back up data to the network server” item on the screen of the portable electronic device. The user then uses a light pen to click on the item on the screen, entering a backup request.

After the network connecting module 102 receives the backup request, the portable electronic device 60 starts to establish signal connections with the network server 70. For example, after the user enters a backup request, the network connecting module 102 follows the GPRS protocol to send out a packet channel request or a packet resource request through the PRACH (Packet Random Access Channel) or the PACCH (Packet Associated Control Channel), obtaining the usage privilege of the channel to a BS. Once the channel usage privilege is obtained, the network connecting module 102 establishes the signal communications with the network server 70.

After the signal communications between the portable electronic device 60 and the network server 70 are established, the backup management module 103 stores at least one set of data in the portable electronic device 60 to the network server 70. For instance, after the signal communications are established, the backup management module 103 follows the settings of the user to send partial data stored in the storage device 603 (such as documents, E-mail messages, partial calendar data or hardware drivers) to the network server 70 through the Internet 90. After the network server 70 receives data transmitted from the backup management module 103, the backup I/O module 104 stores them in the network database 105.

In addition, according to the current embodiment, the backup management module 103 can follow the actions of the user or a request by the operating system or application program of the portable electronic device 60 to automatically send out a data restoration request to the network server 70. The backup I/O module 104 then follows the restoration request to retrieve the data needed by the user, the operating system or the application program and to send the data to the portable electronic device 60.

To make the contents of the invention more comprehensible, an explicit example is given below to demonstrate a preferred embodiment of the disclosed method.

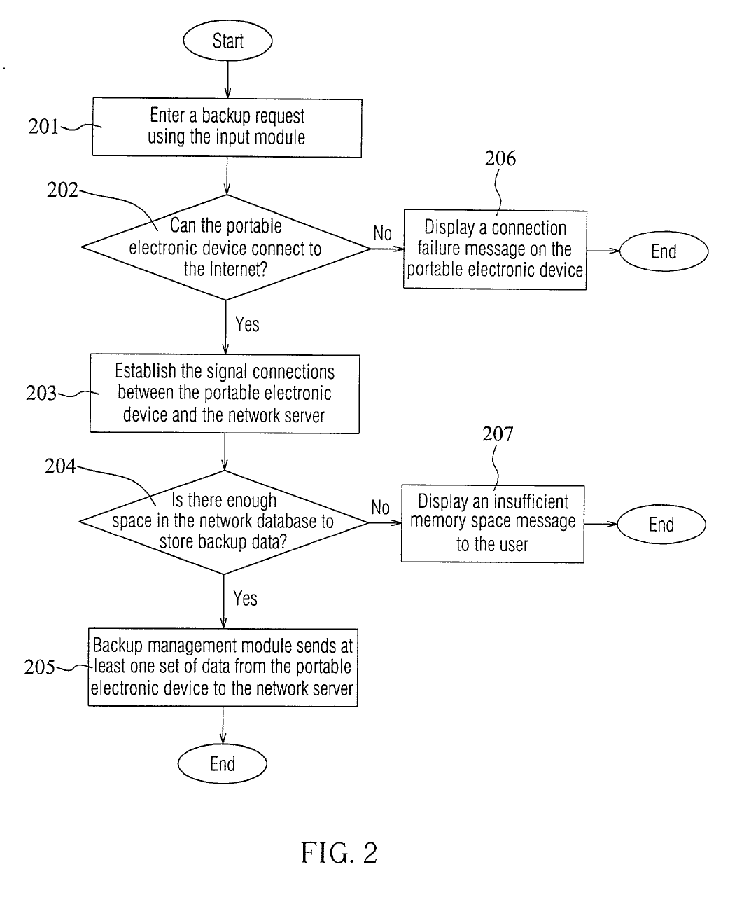

With reference to FIG. 2, a user enters a backup request using the input module 101 in step 201. For example, the user then uses a light pen to write down the website address of the network server 70 on a writing panel or to click the backup button on the screen of the PDA.

Step 202 determines whether the portable electronic device 60 can connect to the Internet 90. For example, when the portable electronic device 60 uses the GPRS protocol to connect to the Internet, step 202 determines whether the communication channel with the gateway GPRS supporting node is successfully obtained. When the portable electronic device 60 is not able to connect to the Internet 90, step 206 is executed and a connection failure message is displayed on the portable electronic device 60 so that the user can search for a better environment for the portable electronic device 60 to connect to the Internet 90 and back up data. For instance, the user can search a desktop computer that is already connected to the Internet and then use the desktop computer to establish signal connections with the Internet 90.

Once the portable electronic device 60 is able to connect to the Internet 90, step 203 starts and the network connecting module 102 establishes the signal connections between the portable electronic device 60 and the network server 70 according to the website address of the network server 70. In this step, if the website address of the network server 70 is manually entered by the user, the network connecting module 102 can directly use the entered website address to establish the connection with the network server 70. If the user clicks on the backup button provided by the input module 101 on the display to perform data backup, the network connecting module 102 uses the built-in website address to establish signal communications.

When the network connecting module 102 successfully establishes the signal connection with the network server, step 204 is performed to determine whether there is enough space in the network database 105 of the network server 70 to store backup data. When the space on the network database 105 is not sufficient, then step 207 displays an insufficient space message on the portable electronic device to the user so that the user can reorganize the data in the network database 105 and delete unnecessary data. For instance, when the available space left in the network database 105 is 2.5 MB and the portable electronic device 60 needs 4 MB space to back up its data, the user has to reorganize the data in the network database 105 and delete unnecessary data so as to free up some memory space in the network database 105.

If the space in the network database 105 is sufficient for backing up data, step 205 is performed for the backup management module 103 to send at least one set of data from the portable electronic device to the network server 70. The backup I/O module 104 then stores the data in the network database 105.

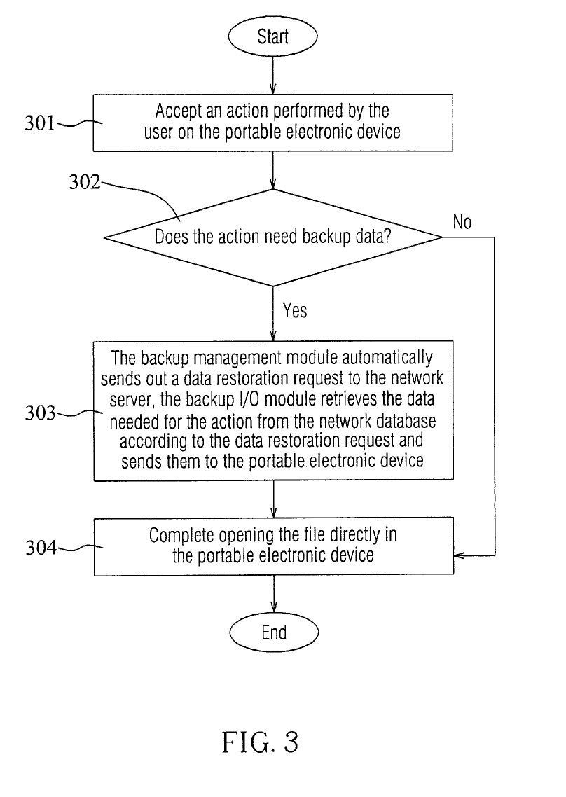

With reference to FIG. 3, step 301 accepts actions performed by the user on the portable electronic device 60 (e.g. opening a file).

In step 302, the backup management module 103 determines whether the action in step 301 needs backup data. If the action does not need any backup data, step 304 is performed to complete opening the file directly in the portable electronic device. On the other hand, if the data in step 301 need backup data, step 303 is performed instead.

In step 303, the backup management module 103 automatically sends out a data restoration request to the network server 70. The backup I/O module 104 follows the data restoration request to retrieve the data needed for the above action and sends the data to the portable electronic device 60. For example, when the user wants a file previously backed up in the network server, the portable electronic device 60 receives the file from the network server 70 through signal communications.

It should be noted that, in this embodiment, when the user gets back the backup data from the network server, no extra selections are needed. In order words, the user can directly select the data he needs on the portable electronic device 60. Whether the data needs to be obtained from the network server 70 through the Internet connection is determined totally by the backup management module 103. This can greatly increase the convenience of operation for the user.

As described before, the disclosed system and method back up the data in the portable electronic device in a network database 105. Therefore, there is a sufficiently large data storage space for backing up data in the portable electronic device 60. Furthermore, the disclosed system and method utilizes the wireless networking function of the portable electronic device to save/retrieve data in the network database 105. Thus, the user can more conveniently perform data backup and restoration.

It should be emphasized that any person skilled in the art can make equivalent modifications of the invention. For example, aside from the GPRS data transmissions, if the portable electronic device has the mobile LAN and/or Bluetooth communication abilities, it can use the 802.11 or Bluetooth protocol to wirelessly connect to a computer device and to back up data to the computer device. In addition to being a BS using the 802.11 protocol or with the Bluetooth transmission ability, the computer device has to have the backup I/O module and the database in the network server. The computer device can then communicate with the backup management module on the portable electronic device for data transmission and backup. Moreover, after the portable electronic device obtains signal communications with the computer device using the 802.11 or Bluetooth protocol and the computer device is connected to the Internet, then the portable electronic device can connect to the Internet via the computer device. The portable electronic device can thus transmit or receive data to and from the network server.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An auto-backup system for a portable electronic device being able to wirelessly-connect to a computer device having a backup I/O module and a database, the auto-backup system comprising:
an input module, with which a user enter a backup request; and
a backup management module, which transmits at least one set of data stored in the portable electronic device wirelessly to the computer device and saves the data in the database through the backup I/O module.

2. The system of claim 1, further comprising:
a network connecting module, which establishes wireless signal communications between the portable electronic device and the computer device.

3. The system of claim 1, wherein the backup management module automatically sends out a data restoration request to the computer device when the portable electronic device is used so that the backup I/O module retrieves the data needed for the task from the database according to the data restoration request and sends the data wirelessly to the portable electronic device.

4. The system of claim 1, wherein the data are in a file.

5. The system of claim 1, wherein the computer device contains a network server.

6. The system of claim 5, wherein the portable electronic device connects wirelessly to the network server using the general packet radio service (GPRS).

7. An auto-backup system for a portable electronic device having an input module, a network connecting module and a backup management module, the auto-backup system comprising:
a database; and
a backup I/O module, which receives at least one set of data transmitted from the backup management module when the input module receives a backup request and the network connecting module establishes wireless signal communications with the computer device and stores the data in the database.

8. The system of claim 7, wherein the backup management module automatically sends out a data restoration request to the computer device when the portable electronic device is used so that the backup I/O module retrieves the data needed for the task from the database according to the data restoration request and sends the data wirelessly to the portable electronic device.

9. The system of claim 7, wherein the data are in a file.

10. The system of claim 7, wherein the computer device contains a network server.

11. The system of claim 10, wherein the portable electronic device connects wirelessly to the network server using the general packet radio service (GPRS).

12. An auto-backup method for a portable electronic device implemented in a system comprising a portable electronic device and a computer device, the portable electronic device including an input module and a backup management module and the computer device including a database and a backup I/O module, the method comprising:
a backup initiating step, in which a user uses the input module to enter a backup request; and
a backup storing step, in which the backup management module transmits at least one set of data stored in the portable electronic device wirelessly to the computer device and the backup I/O module stores the data in the database.

13. The method of claim 12 with the portable electronic device further including a network connecting module and the method further comprising a network connecting step, in which the network connecting module establishes wireless signal communications between the portable electronic device and the computer device.

14. The method of claim 12 further comprising a data restoration step, in which the back up management module automatically sends out a data restoration request to the computer device when the portable electronic device is used and the backup I/O module retrieves the data needed for the task from the database according to the data restoration request and sends the data to the portable electronic device.

15. The method of claim 12, wherein the data are in a file.

16. The method of claim 12, wherein the computer device contains a network server.

17. The method of claim 16, wherein the portable electronic device connects wirelessly to the network server using the general packet radio service (GPRS).
